(19) United States
(12) Patent Application Publication
(10) Pub. No.: US 2014/0039968 A1
(43) Pub. Date: Feb. 6, 2014

(54) INTEGRATION OF MODELED COLLABORATION STREAM IN BUSINESS PROCESS FLOW

(71) Applicants: Bare Said, Sankt Leon-ROT (DE); Frank Brunswig, Heidelberg (DE); Klaus Herter, Leimen (DE)

(72) Inventors: Bare Said, Sankt Leon-ROT (DE); Frank Brunswig, Heidelberg (DE); Klaus Herter, Leimen (DE)

(73) Assignee: SAP AG, Walldorf (DE)

(21) Appl. No.: 13/567,438

(22) Filed: Aug. 6, 2012

(51) Int. Cl. G06Q 10/06

(52) U.S. Cl. 705/7.26

(57) ABSTRACT

In accordance with aspects of the disclosure, a system and methods are provided for managing a business process flow based on business process constraints for structured business activities and collaborative process demands for unstructured business activities while maintaining a collaboration stream between the structured and unstructured business activities. The systems and methods may include integrating a collaboration business process integration model with a collaboration metadata model by aligning the business process constraints for the structured business activities with the collaborative process demands for the unstructured business activities. Further, the systems and methods may include scheduling a sequence of structured business activities based on the business process constraints for the structured business activities and the collaborative process demands for the unstructured business activities while maintaining the collaboration stream between the structured and unstructured business activities.

### TECHNICAL FIELD

The present description relates to computer-based techniques for business process flow management.

### BACKGROUND

Software application and development environments based on business objects provide for ease of development and use of related software applications. For instance, business objects may be used to encapsulate defined attributes, values, and associated data, as well as related logic and/or associated behaviors. Thus, a business object may correspond to, or represent, a specific technical, semantic, and/or tangible entity that is known to have certain properties and capabilities, and may interact with other business objects representing corresponding entities to thereby collectively provide a desired functionality. Due to their modular properties and other known aspects, business objects may enable fast, convenient development of highly customized software applications that are straightforward for a developer to implement, and likely to fulfill needs and requirements of consumers or other users thereof.

Meanwhile, people centric parts of business processes may be executed in various collaboration environments where existing tools have matured to be best practices, which may be considered as representing collaboration. Recently, social media has delivered a valuable innovation for collaborative workforces and provide meaningful patterns that are relevant for business usage. The working paradigm of social media is easy to understand and provides instant execution capabilities for people interaction activities. However, the current situation in business appears as a side-by-side situation that still requires people to have individual knowledge to bridge the people centric space and the model driven part of process execution.

### SUMMARY

In accordance with aspects of the disclosure, a computer system may be provided for business process flow management including instructions recorded on a non-transitory computer-readable medium and executable by at least one processor. The computer system may include a collaboration manager configured to cause the at least one processor to manage a transactional business process flow based on business process constraints for structured business activities and collaborative process demands for unstructured business activities while maintaining a collaboration stream between the structured and unstructured business activities. The collaboration manager may include a business process handler configured to derive a collaboration business process integration model for the structured business activities and a collaboration handler configured to derive a collaboration metadata model for the unstructured business activities based on collaborative responses to each structured business activity. The collaboration manager may include an integration handler configured to integrate the collaboration business process integration model with the collaboration metadata model by aligning the business process constraints for the structured business activities with the collaborative process demands for the unstructured business activities. The collaboration manager may include a transaction optimizer configured to schedule a sequence of structured business activities based on the business process constraints for the structured business activities and the collaborative process demands for the unstructured business activities while maintaining the collaboration stream between the structured and unstructured business activities.

In accordance with aspects of the disclosure, a computer-implemented method may be provided for managing a transactional business process flow based on business process constraints for structured business activities and collaborative process demands for unstructured business activities while maintaining a collaboration stream between the structured and unstructured business activities. The computer-implemented method may include deriving a collaboration business process integration model for the structured business activities, deriving a collaboration metadata model for the unstructured business activities based on collaborative responses to each structured business activity, integrating the collaboration business process integration model with the collaboration metadata model by aligning the business process constraints for the structured business activities with the collaborative process demands for the unstructured business activities, and scheduling a sequence of structured business activities based on the business process constraints for the structured business activities and the collaborative process demands for the unstructured business activities while maintaining the collaboration stream between the structured and unstructured business activities.

In accordance with aspects of the disclosure, a computer program product may be provided, wherein the computer program product is tangibly embodied on a computer-readable storage medium and includes instructions that, when executed by at least one processor, are configured to manage a transactional business process flow based on business process constraints for structured business activities and collaborative process demands for unstructured business activities while maintaining a collaboration stream between the structured and unstructured business activities. The instructions, when executed by the at least one processor, may be configured to derive a collaboration business process integration model for the structured business activities, derive a collaboration metadata model for the unstructured business activities based on collaborative responses to each structured business activity, and integrate the collaboration business process integration model with the collaboration metadata model by aligning the business process constraints for the structured business activities with the collaborative process demands for the unstructured business activities. The instructions, when executed by the at least one processor, may be configured to schedule a sequence of structured business activities based on the business process constraints for the structured business activities and the collaborative process demands for the unstructured business activities while maintaining the collaboration stream between the structured and unstructured business activities.

As provided herein, details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating an example system for managing business process flow, in accordance with aspects of the disclosure.

FIG. 2 is a process flow illustrating an example method for managing business process flow, in accordance with aspects of the disclosure.

FIG. 3 shows an example integration of a standard transactional business process flow with a collaboration business process flow, in accordance with aspects of the disclosure.

FIG. 4 shows an example metadata model integration, in accordance with aspects of the disclosure.

### DETAILED DESCRIPTION

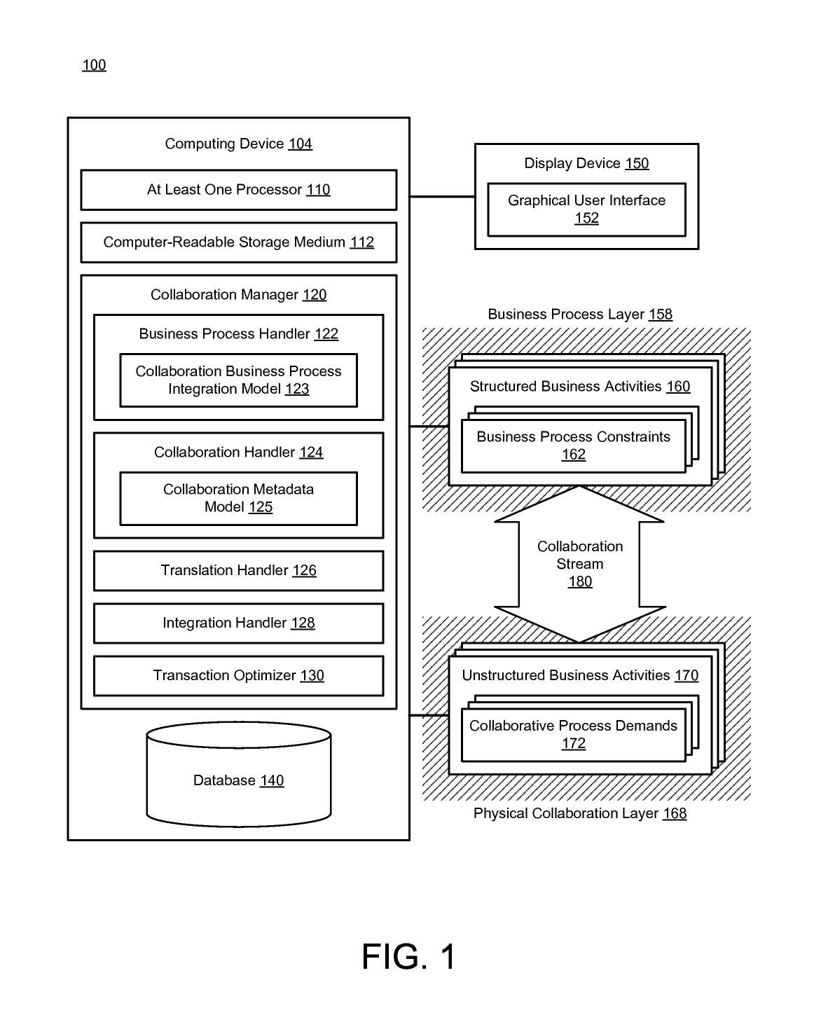

FIG. 1 is a block diagram illustrating an example system 100 for managing business process flow, in accordance with aspects of the disclosure. The example system 100 may be used to enable a model based integration of collaborative process(es) that may be considered essential components of customer end-to-end business process(es) with a standard business process reflected in the example system 100 without limiting flexibility and comfort of people centric interaction patterns.

In the example of FIG. 1, the system 100 comprises a computer system for implementing a business process flow management system that may be associated with a computing device 104, thereby transforming the computing device 104 into a special purpose machine designed to determine and implement the transactional process(es), as described herein. In this sense, it may be appreciated that the computing device 104 may include any standard element(s), including at least one processor(s) 110, memory (e.g., a non-transitory computer-readable storage medium) 112, power, peripherals, and various other computing elements not specifically shown in FIG. 1. Further, the system 100 may be associated with a display device 150 (e.g., a monitor or other display) that may be used to provide a graphical user interface (GUI) 152. In an implementation, the GUI 152 may be used, for example, to receive preferences from a user for managing or utilizing the system 100. It should be appreciated that various other elements of the system 100 that may be useful to implement the system 100 may be added or included, as would be apparent to one of ordinary skill in the art.

As such, in the example of FIG. 1, the business process flow management system 100 may include the computing device 104 and instructions recorded on the non-transitory computer-readable medium 112 and executable by the at least one processor 110. In an implementation, the business process flow management system 100 may include the display device 150 for providing output to a user, and the display device 150 may include the graphical user interface (GUI) 152 for receiving input from the user.

The business process flow management system 100 may include a collaboration manager 120 configured to cause the at least one processor 110 to manage a transactional business process flow based on one or more business process constraints 162 for one or more structured business activities 160 and one or more collaborative process demands 172 for one or more unstructured business activities 170 (e.g., relative to one or more time intervals) while maintaining a collaboration stream 180 between the structured and unstructured business activities 160, 170. In various implementations, the collaborative process demands may include one or more of customer demands, supplier demands, and/or producer demands (e.g., production demands).

In an implementation, the collaboration manager 120 may be configured to implement, manage, and/or maintain a collaboration business flow between structured and unstructured business activities 160, 170 via, for example, an exchange of data including data related to each business constraint 162 (i.e., business constraint data) and data related to each customer demand (i.e., customer demand data). For instance, data related to each customer demand 172 of each unstructured business activity 170 may be provided to each structured business activity 160, and data related to each business constraint 162 of each structured business activity 160 may be provided to each unstructured business activity 170 for maintaining the collaboration stream 180 between the structured and unstructured business activities 160, 170.

In an implementation, the collaboration stream 180 may be defined as a set of objectives (e.g., business objectives, business goals, etc.) achieved by collaboration between the structured and unstructured business activities 160, 170.

In the example of FIG. 1, the collaboration manager 120 may include a business process handler 122 configured to derive a collaboration business process integration model 123 for the structured business activities 160 (e.g., within the one or more time intervals).

In an implementation, the structured business activities 160 may comprise application defined business activities related to a business process layer 158. In another implementation, the application defined business activities may comprise application-specific interaction business activities related to the business process layer 158.

The collaboration manager 120 may include a collaboration handler 124 configured to derive a collaboration metadata model 125 for the unstructured business activities 170 (e.g., within the one or more time intervals) based on one or more collaborative responses to each structured business activity 160.

In various implementations, the unstructured business activities 170 may comprise customer/supplier/producer defined business activities related to a physical collaboration layer 168. In another implementation, the customer/supplier/producer defined business activities may comprise personal interaction business activities related to the physical collaboration layer 168.

The collaboration manager 120 may include a translation handler 126 configured to provide one or more translations between the business process layer 158 and the physical collaboration layer 168. In an example, the business process layer 158 is configured to provide the business process constraints 162 for the structured business activities 160, and the physical collaboration layer 168 is configured to provide the collaborative process demands 172 for the unstructured business activities 170. In various examples, as described herein, the collaborative process demands may include one or more of customer demands, supplier demands, and/or producer demands.

The collaboration manager 120 may include an integration handler 128 configured to integrate the collaboration business process integration model 123 with the collaboration metadata model 125 by aligning each business constraint 162 for each structured business activity 160 with each customer demand 172 for each unstructured business activity 170. In an example, integration may be achieved by aligning available supplier and production capabilities with each customer demand 172.

In an implementation, the integration handler 128 may be configured to link each structured business activity 160 with a corresponding collaborative response from one or more of the unstructured business activities 170.

In another implementation, the integration handler 128 may be configured to link each collaborative response from one or more of the unstructured business activities 170 with a corresponding structured business activity 160.

In another implementation, the integration handler 128 may be configured to receive business constraint data for the collaboration business process integration model 123 and customer demand data for the collaboration metadata model 125 in an ordered sequence to maintain consistency between structured business activities 160 and the unstructured business activities 170.

The collaboration manager 120 may include a transaction optimizer 130 configured to schedule a sequence of structured business activities 160 based on the business process constraints 162 for the structured business activities 160 and the collaborative process demands 172 for the unstructured business activities 170 (e.g., relative to the one or more time intervals) while maintaining the collaboration stream 180 between the structured and unstructured business activities 160, 170. In various examples, the collaborative process demands may include one or more of customer demands, supplier demands, and/or producer demands (e.g., production demands).

In an implementation, the transaction optimizer 130 may be configured to schedule the sequence of structured business activities 160 in parallel.

Referring to the example of FIG. 1, in conjunction with the collaboration manager 120, the business process flow management system 100 may be configured to select an optimal or near-optimal business activity scheduling solution that may define one or more specific time intervals for managing the transactional business process flow by maintaining the collaboration stream 180 between the structured business activities 160 and the unstructured business activities 170 to thereby obtain desired results, such as, for example, increased efficiency, productivity, and profitability.

As such, the business process flow management system 100 of FIG. 1 (in particular, the collaboration manager 120) may be configured to provide an optimal or at least near-optimal business activity scheduling solution, in a quick, efficient, and reliable manner. The system 100 may also be configured to provide one or more simulations of possible business activity scheduling solutions (e.g., potential scheduling schemes), as well as associated “what-if” scenario modeling of business activity scheduling that allows for informed decisions about everyday business practices and transactions.

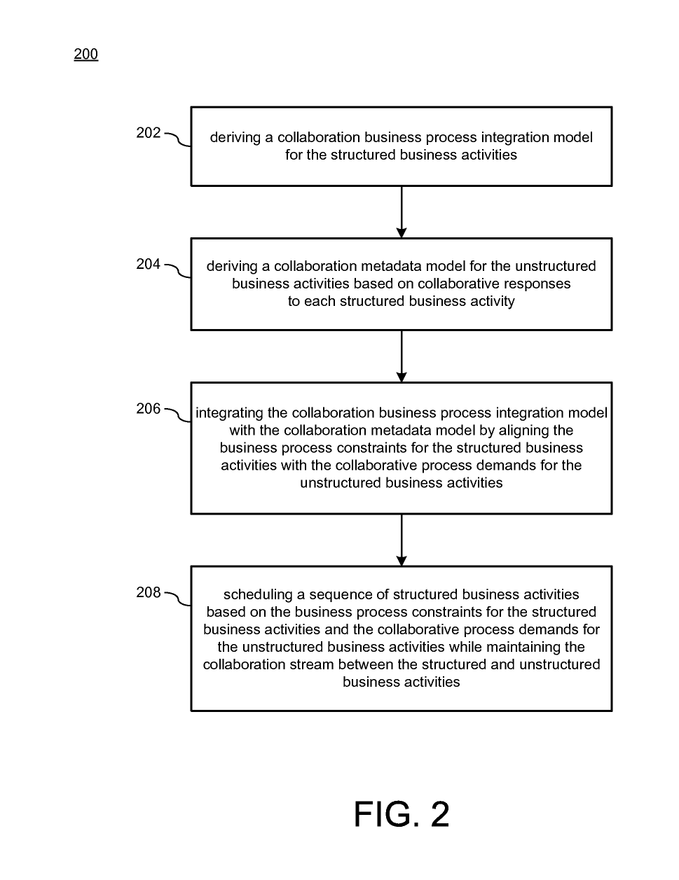

FIG. 2 is a process flow illustrating an example method 200 for managing business process flow, in accordance with aspects of the disclosure. In the example of FIG. 2, operations 202-208 are illustrated as discrete operations occurring in sequential order. However, it should be appreciated that, in other implementations, two or more of the operations 202-208 may occur in a partially or completely overlapping or parallel manner, or in a nested or looped manner, or may occur in a different order than that shown. Further, additional operations, that may not be specifically illustrated in the example of FIG. 2, may also be included in some implementations, while, in other implementations, one or more of the operations 202-208 may be omitted.

In the example of FIG. 2, the method 200 may include a process flow for a computer-implemented method for managing transactional business process flow in the system 100 of FIG. 1. Further, as described herein, the operations 202-208 are configured to provide a simplified operational process flow that may be enacted by the computing device 104 to provide features and functionalities as described in reference to FIG. 1.

In an aspect of the disclosure, the method 200 is provided for managing a transactional business process flow based on the business process constraints 162 for structured business activities 160 and the collaborative process demands 172 for unstructured business activities 170 (e.g., relative to one or more time intervals) while maintaining the collaboration stream 180 between the structured and unstructured business activities 160, 170. In various implementations, as described herein, the collaborative process demands may include one or more of customer demands, supplier demands, and/or producer demands (e.g., production demands).

In the example of FIG. 2, at 202, the method 200 may include deriving a collaboration business process integration model 123 for the structured business activities 160 (e.g., within the one or more time intervals). In an implementation, the structured business activities 160 may comprise application defined business activities of the business process layer 158, and the application defined business activities may comprise application-specific interaction business activities of the business process layer 158.

At 204, the method 200 may include deriving a collaboration metadata model 125 for the unstructured business activities 170 (e.g., within the one or more time intervals) based on collaborative responses to each structured business activity 160. In an implementation, the unstructured business activities 170 may comprise customer defined business activities (including supplier and/or producer defined business activities) of the physical collaboration layer 168, and the customer/supplier/producer defined business activities may comprise various personal interaction business activities of the physical collaboration layer 168.

At 206, the method 200 may include integrating the collaboration business process integration model 123 with the collaboration metadata model 125 by aligning each of the business process constraints 162 for the structured business activities 160 with each of the collaborative process demands 172 for the unstructured business activities 170. In an implementation, aligning the business process constraints 162 for the structured business activities 160 with the collaborative process demands 172 for the unstructured business activities 170 may include aligning available supplier and production capabilities with each customer demand 172.

At 208, the method 200 may include scheduling a sequence of structured business activities 160 based on the business process constraints 162 for the structured business activities 160 and the collaborative process demands 172 for the unstructured business activities 170 (e.g., relative to the one or more time intervals) while maintaining the collaboration stream 180 between the structured and unstructured business activities 160, 170. In an implementation, the sequence of structured business activities 160 may be scheduled in parallel. In various examples, as described herein, the collaboration stream 180 may be defined or may be referred to as a set of objectives (e.g., business objectives, business goals, etc.) achieved by collaboration between the structured and unstructured business activities 160, 170.

In an implementation, the method 200 may further include providing one or more translations between the business process layer 158 configured to provide the business process constraints 162 for the structured business activities 160 and the physical collaboration layer 168 configured to provide the collaborative process demands 172 for the unstructured business activities 170.

In another implementation, the method 200 may further include providing a link between each structured business activity 160 and a corresponding collaborative response and providing another link between each collaborative response and a corresponding structured business activity 160.

In another implementation, the method 200 may further include providing business constraint data for the collaboration business process integration model 123 and providing customer demand data for the collaboration metadata model 125 in an ordered sequence to maintain consistency between structured business activities 160 and the unstructured business activities 170. Accordingly, data related to each customer demand 172 (i.e., customer demand data) may be provided to each structured business activity 160, and data related to each business constraint 162 (i.e., business constraint data) may be provided to each unstructured business activity 170.

In some implementations, business process flow management may involve providing and implementing various business process models that enable customers to reflect their enterprise resource planning processes in a software processing system. The various business process models may describe and support structured end-to-end standard business processes, events, and activities. In some examples, customer-defined business processes may deviate from standard business processes provided, implemented, and/or configured in the software processing system. Some additional processing steps may be executed by the customer and employees thereof in a collaborative approach via various media and external tools to execute and run the customer-defined business processes. In some examples, collaboration steps running outside the software processing system may be considered as unstructured business activities carried out on the customer side, and thus, the collaboration process steps may not be captured or supported by the software processing system. However, from a customer point of view, those collaboration process steps may be well-defined and well-structured and, as such, may be essential steps to run the end-to-end business process defined by the customer.

Accordingly, aspects of the present disclosure are configured to integrate in a modeled approach the collaborative process steps that are essential parts of the customer end-to-end business process in the standard business process reflected in the software processing system. In an implementation, integration of collaboration process steps in a standard transactional business process flow may cover exposing appropriate business process data and/or activities to the collaboration stream and may also cover capturing and referencing relevant data and/or activities created or executed outside of the software processing system during the collaboration process to achieve full traceability and transparency of the entire business process.

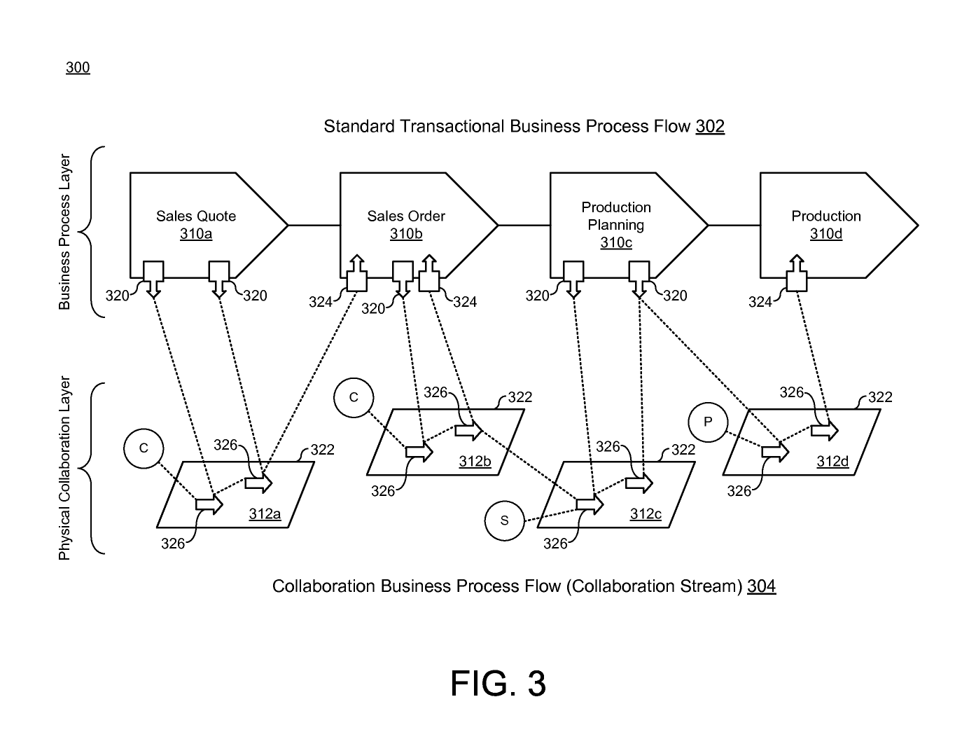

FIG. 3 shows an example integration 300 of a standard transactional business process flow 302 with a collaboration business process flow 304, in accordance with aspects of the disclosure. Further, FIG. 3 shows the example integration 300 having a collaboration stream of collaboration metadata models 312 (e.g., collaboration metadata models 312a, 312b, 312c, 312d) for exposing, consumption, and tracing within collaboration business process integration models 310 (e.g., collaboration business process integration models 310a, 310b, 310c, 310d), in accordance with aspects of the disclosure.

In the example of FIG. 3, the integration 300 shows an implementation of managing the standard transactional business process flow 302 with collaboration from the collaboration business process flow 304 based on business process constraints for structured business activities and collaborative process demands for unstructured business activities (e.g., relative to one or more time intervals) while maintaining the collaboration stream between the structured and unstructured business activities.

In an implementation, a collaboration business process integration model may be derived for the structured business activities (e.g., within the one or more time intervals). For example, the standard transactional business process flow 302 may be modeled with one or more collaboration business process integration models 310 including, for example, a sales quote business model 310a, a sales order business model 310b, a production planning business model 310c, and a production business model 310d.

In this implementation, a collaboration metadata model may be derived for the unstructured business activities (e.g., within the one or more time intervals) based on collaborative responses form the collaboration stream to each structured business activity. For example, the collaboration business process flow 304 may be modeled with one or more collaboration metadata models 312 including, for example, collaboration metadata models for manual collaboration work related to sales quote collaboration 312a, sales order collaboration model 312b, production planning collaboration model 312c, production planning collaboration model 312d. In various examples, the collaborative process demands from the collaboration stream may include one or more customer demands from one or more customers (C), one or more supplier demands from one or more suppliers (S), and/or one or more producer demands (e.g., production demands) from one of more producers (P).

Further, in this implementation, the collaboration business process integration model(s) may be integrated with the collaboration metadata model(s) by aligning the business process constraints for the structured business activities with the collaborative process demands for the unstructured business activities. In addition, a sequence of structured business activities may be scheduled based on the business process constraints for the structured business activities and the collaborative process demands for the unstructured business activities (e.g., relative to the one or more time intervals) while maintaining the collaboration stream between the structured and unstructured business activities.

For example, a sales order 310b may only be handed over to production 310d when an individual specification was aligned with a customer of a make to order process. In addition, a third-party supplier may need to deliver specific parts so as to fulfill the customer individual needs (i.e., collaborative process demands).

On a business process level (standard transactional business process flow supported by the system), there may only be a sales order with a set of visible sales order items. In some cases, notes on an item level or attached documents may briefly outline that there is some additional activities that may need to be carried out and some additional data that may have to be collected to go ahead with the business process. The concrete business activities and collected business data may stay hidden and may not be reflected or available in the system where the entire business process is supposed to be reflected. FIG. 3 illustrates these ideas in a graphical manner.

For instance, FIG. 3 shows the standard transactional business process flow 302 as a modeled standard business process reflected in the system, and FIG. 3 further shows the collaboration business process flow 304 as a modeled customer (and/or supplier, and/or producer) defined business process that may be referred to as a standard business process enhanced with collaboration process steps (e.g., from a customer, a supplier, and/or a processor), in accordance with aspects of the disclosure.

In an implementation, a sales responsible may have a challenge of aligning customer individual demands with respect to corresponding business process constraints, such as for example, pricing and delivery timelines. The callback to engineering and production may be complex and necessitate additional alignment cycles with other business process constraints, such as, for example, supplier and production capabilities. In such example, an expected sales price (e.g., due to a request for a discount) and the proposed delivery date may need to be determined via collaboration steps as a regular product availability check and regular price calculation may not be feasible because individual customer requirements may not be considered in the standard business process relying on standard products. Thus, the proposed delivery data, the price, and/or veto information collected and created external to the system may have to be retrofitted again to the system to continue the process and to ensure a complete traceability.

As such, referring to the example of FIG. 3, aspects of the disclosure refer to a solution that offers coupling the collaboration stream in a systemic manner with the standard business process on a metadata and model level. Collaboration metadata models and a corresponding runtime engine may be defined and introduced to be seamlessly integrated with existing collaboration business process integration models and their executions. The introduced metadata models and the enhanced existing metadata models may express the nature of collaboration execution from a model perspective and may offer a rich set of collaboration capabilities driven by best practice experiences. These metadata models may be configured to maintain execution flexibility via collaboration tools and operate on modeled business data by extracting and returning back collaboration relevant data into the transactional level of process execution.

These introduced collaboration entities may be configured to cover and enable exposing and providing relevant business data to an activated collaboration step or collaboration stream, define a collaboration stream as a set of objectives to be achieved by means of defined activities and used media, and link results of the collaboration stream with original business process entities and capturing all collaboration activities executed out of the standard system of record.

In the example of FIG. 3, collaboration between the standard transactional business process flow 302 and the collaboration business process flow 304 may be achieved with one or more collaboration metadata elements including, for example, a collaboration data provider (CDP) 320, a collaboration process component (CPC) 322, a collaboration data consumer (CDC) 324, and a collaboration execution (CE) 326. In an implementation, these collaboration metadata elements 320, 322, 324, 326 may be configured to provide for translation between the business process layer (related to the standard transactional business process flow 302) and the physical collaboration layer (related to the collaboration business process flow 304). The business process layer may be configured to provide the business process constraints for the structured business activities and the physical collaboration layer may be configured to provide the collaborative process demands for the unstructured business activities.

In an implementation, the collaboration data provider (CDP) 320 provides output data and information for identifying and outlining one or more business goals and extracting relevant business data for collaborative execution. For instance, each business goal (e.g., related to timing, constraints, conditions, etc.) and relevant business data may be related to technology used in production and known artifacts. The CDP 320 may provide for identifying collaboration relevant business data and extracting and exposing business data at a scenario level. Collaboration relevant business data may be identified and define metadata object to be exposed for collaborative execution. The CDP 320 are identified from a business scenario perspective only that is independent from the collaboration execution decisions. The manner in which collaborative business results are achieved may be considered an interactive decision by collaboration parties decoupled from the existing structured business data.

In an implementation, the collaboration process component (CPC) 322 and the collaboration execution (CE) 326 provide for collaborative execution of the business goals using relevant business data and usage types. Further, the CPC 322 and the CE 326 may be configured to provide collaborative responses to each structured business activity via the CDC 324. For instance, collaborative processing and execution may be related to various personal activities including, for example, mail delegation, task definition, collect action in activities, meeting activities, etc. In another instance, collaborative execution may be related to connection to social media and supporting features, including, for example, subscribe/follow stay→informed, tags/flags→ad hoc classification categorization, publish and share→provide context and delegate responsibility. The CPC 322 and the CE 326 may provide for collaborative processing and execution including known artifacts, mail, task, activity, share, subscribe, etc. The collaboration execution may be based on exposed business data on one hand but has clear defined business objectives. Each collaboration execution step may be decided with respect to the expected results to be delivered. The sequence, nature, and interdependencies need to be decided flexibly as the nature of these collaboration execution steps are quite dynamic with changing constraints and a huge variety of contributing parties, environmental conditions, and shared content. In some instances, the CPC 322 and the CE 326 may be configured to pass information related to collaborative responses to each other.

In an implementation, the collaboration data consumer (CDC) 324 provide input data and information for collecting and aggregating results for document and transfer for next step scenario execution. For instance, business processing may include bring in data in a right sequence and order to maintain consistency between structured and unstructured business activities. As such, data related to collaborative process demands (i.e., customer demand data) may be provided to each structured business activity, and data related to each business constraint (i.e., business constraint data) may be provided to each unstructured business activity. The CDC 324 provide for aggregate, document results and for mapping collaboration results into the transactional scenario execution. The collaboration results (i.e., the CDC 324) may be considered a counter part of the collaboration relevant data exposed via collaboration enablement objects. They may be identified from a business scenario perspective only that is independent from the collaboration execution decisions. The manner in which collaborative business results are achieved is typically an interactive decision by the collaboration parties decoupled from the existing structured business data. The collaboration execution is responsible for mapping the collaboration result into the transactional scenario execution.

In various implementations, the collaborative process demands provided by the collaboration stream may include customer related demands (e.g., demands related to sales objectives, customer alignments, customer changes, etc.) from each customer (C), supplier related demands (e.g., demands related to supplier inventories, supplier alignments, supplier changes, etc.) from each supplier (S), and/or producer related demands or production related demands (e.g., demands related to production capacities, production resource breaks, production site decisions, production alignments, production changes, etc.) from each producer (P).

In various implementations, one or more principles provide base for model centric collaboration. For instance, business entities of the transactional business process flow may be used to expose relevant business data for collaborative process execution. The scope of exposure may vary from node level but may include BO status information and may be enabled to expose extension scope of a core BO. The exposure of collaboration relevant information may not be limited to core BO elements but may include a process component level including process agent representations. A rich knowledge base may be available on development, solution management, consultant, and customer level that may be the base to identify and expose the required level of business information. At the same time, legal standards build an additional definition source for collaboration enablement (e.g., governance processes, legal requirement, etc.). Collaborative process execution may be done within the collaboration process component (CPC) based on the exposed business data. The CPC may be configured to provide different artifacts that follow the people centric approach like create task/activity, invite people to it, stay informed on a business topic by feed, follow a business entity, a person or a business context. As such, the social media content and execution paradigm provides a rich set of execution capabilities to extend the traditional flow of information.

Further, focus on collaboration process result may be considered key to enable the appropriate business response into the transactional business process flow. Collaboration enablement objects (CEO) may be introduced as a new category meta data objects in the role of a collaboration data provider (CDP, as outport) or a collaboration data consumer (CDC, as inport). The role of the CDC is assigned with the semantic of the collaboration results that need to be mapped into the scenario flow from a concept point of view. Collaboration execution steps represent the execution steps where the required collaboration result need to be worked out. An important principle is the manner in which collaboration execution steps are invoked and combined is still a user centric decision by the collaborating business experts with the focus on keeping today's matured flexibility. This is where the described unstructured process execution may be allowed to happen. The difference is that it is now executed within a modeled ‘process frame’ that has clear anchor points and business objectives. The benefit may be the strength of how both execution levels are retained and how the collaborative interaction knowledge obtains a methodology. At the same time, this approach may allow a process extension and improvement on a continuous base as it may be considered an anchoring on an uncovered metadata level. The collaboration process steps are flexible and included in the business flow model to achieve visibility for all contributing parties and provides an embedded set of collaboration methods. Further, consuming the results of a business collaboration component (CDC) may define the complementary part of the business data exposure, which may be an integration into the transactional business process flow. The status change of a business object, e.g., the release of a sales order may be connected to the customer alignment which was achieved, e.g., with CE step.

For example, in the example of FIG. 3, a sales quote may be modeled 310a to provide sales quote data, regarding business goals, timing, parameters, constraints, conditions, etc., to the collaboration stream via CDP 320. In response, the CPC 322 may receive the sales quote data, and a collaborative response to the sales quote may be modeled 312a to provide collaboration data for a sales quote request, which may include data related to collaborative process demands and conditions, to CDC 324.

Further, in the example of FIG. 3, a sales order may be modeled 310b to provide sales order data, regarding business goals, timing, parameters, constraints, conditions, collaborative process demands and conditions, etc., to the collaboration stream via CDP 320. In response, the CE 326 may receive the sales order data, and a collaborative response to the sales order may be modeled 312b to provide collaboration execution for a sales order request, which may include data related to business goals, timing, parameters, constraints, conditions, collaborative process demands and conditions, to CDC 324.

Further, in the example of FIG. 3, production planning may be modeled 310c to provide production planning data, regarding business goals, timing, parameters, constraints, conditions, etc., to the collaboration stream via CDP 320. In response, the CPC 322 and the CE 326 may receive the production planning data, and a collaborative response to the production plan may be modeled 312c, 312d to provide collaboration data for a production planning request, which may include data related to additional collaborative process demands and conditions, to CDC 324.

Further, in the example of FIG. 3, production and delivery may be modeled 310d to receive production and delivery data, regarding business goals, timing, parameters, constraints, conditions, collaborative process demands and conditions, etc., from the collaborative response model 310d via the CDC 324.

In some instances, an appropriate definition of the collaboration metadata and the right linkage to other metadata models may be based on an assumption that collaboration relevance for a business process is known on a business object element, on a process component level, and on a scenario level. As such, collaboration between the standard transactional business process flow 302 and the collaboration business process flow 304 may seek to combine the business environment with physical collaboration by inviting the right people to derive business goals within a time frame, such as one or more particular time intervals, wherein each person may be responsible for their own activities within each particular time interval. In various implementations, those in physical collaboration with the business environment may be free to work around the business frame or framework through, for example, social media and various usage types associated therewith.

In accordance with aspects of the disclosure, the term “business object” may be understood to represent, virtually any software object that seeks to encapsulate data and associated methods, and which represent an entity within a modular software development environment. Generally, such software objects may be known by many different nomenclatures and terminologies, and may include, for example, enterprise java beans (EJBs), advanced business application programming (ABAP) objects, business objects, and/or variations thereof.

In some examples, references are made primarily to business objects in corporate or enterprise settings. However, it should be appreciated that the term business should be understood to represent virtually any profit related activities associated with a legal entity, as well as various not-for-profit entities, such as, for example, schools, governmental entities, charitable entities, the military, or any other entity which may benefit from the modular software development techniques described herein.

Referring to the example of FIG. 3, integration of the collaboration stream at the customer side may be achieved via configuration and activation of one or more collaboration artifacts that are linked with other business process artifacts. The metadata and metadata entities related or defined by the collaboration stream may be configured to cover different aspects, such as, for example, data exposing, data consumption, and/or definition of collaboration activities. An appropriate runtime engine for collaboration streams processes controls and ensures execution of defined collaboration steps. The activation of the collaboration stream on the scenario level may lead to different behavior of business objects and/or process component interactions. Those different behaviors are enabled and supported via the one or more collaboration data providers (CDP) 320 and the one or more collaboration data consumers (CDC) 324. In some implementations, the business object status transition may be interrupted and a new status may be added. In other implementations, start conditions and receivers of a process agent may be changed or extended to enrich the standard message based communications between system components with additional collaborative steps.

In an implementation, assignment on the process component level delivers a model that may allow for a flexible definition of collaboration enablement objects. This variant combines business object (BO) based information and composes the BO based information to a joined collaboration view as necessary from the collaborative business objectives. An example may include a process component referred to as ‘PRODUCTION MODEL MANAGEMENT’ where a production bill of material, a production bill of operations, and production model data may be composed in a single collaboration data provider (CDP) meta object. In this case, the collaboration process execution may be done with focus to release a production model (BO), wherein the production model (e.g., BO ReleasedExecutionProcutionModel) may provide the master data for the execution of a production process that may be a complex iteration of multiple input values, constraints, and the given setup of a customers production landscape. In some cases, an external supplier or production capabilities from external partners may need to be considered, which may be a challenge for the production experts.

Further, in this implementation, data in a released execution production model may be created by copying original master data found in the associated production model at a given point in time. This approach may deliver the input values for the CDP collection. In an example, as soon as the released execution production model is created for the execution, it needs to provide a consistent read-only version of the production model. This standard may deliver a vital example of a context where the collaboration business flow provides the perfect staging level for the transactional business process flow. At the same time, a new level of transparency may be achieved by the connection between collaboration relevant business data and the related collaborative mapped into the transactional business process flow.

In accordance with aspects of the disclosure, the system and methods described herein are configured to integrate essential collaborative process steps in a modeled approach, wherein integration of collaborative process steps in a standard business process covers exposing appropriate business process data to the collaboration stream and covers capturing and referencing the relevant data and activities created or executed outside the structured system during the collaboration process.

For instance, in an implementation, collaboration may be used to provide a reusable pattern that may be applied to collaboration in business activities for structured activities (tasks) and unstructured activities (tasks) including personal interaction business activities, such as customer defined business activities, supplier defined business activities, and/or producer defined business activities. The systems and methods may be configured to manage transactional business flow by bringing in data in a right sequence and order to maintain consistency between structured activities and unstructured activities. As such, the systems and methods may be configured to collaborate structured business activities (e.g., application defined business activities including application-specific interaction business activities) with unstructured business activities (e.g., one or more personal interaction business activities). In an example, customer defined business processes may be referred to as an application defined business process enhanced with collaboration process steps from a customer, a supplier, and/or a producer. The systems and methods may be configured to align collaborative process demands with business parameters (e.g., quantity data, pricing data, delivery data, veto data) and align collaborative process demands with supplier and production capabilities. The systems and methods may be configured to derive business goals within a timeline, wherein each collaborative entity is responsible for own activities within the timeline, time frame, or time interval.

With reference to specific examples in a traditional corporate or enterprise context, it may be appreciated that various business objects used within the business object based application environment may represent defined entities that exist in such environments. For instance, within a specific enterprise, a business object may exist to relate to an entity, such as, for example, customer, sales order, delivery, employee, physical resource including a building, piece of equipment, or any other semantic, technical, and/or tangible entity which may exist in, or be utilized by, the enterprise in question. Such entities and associated business objects are known to one of skill in the art, and therefore are not described here in further detail except as may be necessary or helpful in understanding example operations of the disclosure.

In an aspect of the disclosure, the business object based application environment may be associated with a number of developmental entities and associated development tools that are designed to allow developers to generate functionalities and results using existing business objects. For instance, developmental tools may include tools for generating a graphical user interface (GUI) based on one or more business objects, and/or may include report generation tools which enable business objects to generate reports and other analyses of data included in, or associated with, one or more business objects. Such developmental tools including other features and functions of a business object based application environment illustrate, for example, the nature and extent of interoperability between business objects, as well as the ease and flexibility of use of the business objects in obtaining a desired result.

In another aspect of the disclosure, one or more external applications may be configured to execute on remote servers that are in communication with the business object based application environment via an appropriate computer network (e.g., the Internet). Such applications may be configured to provide features and functionalities that may be useful or advantageous to a developer utilizing a business object based application environment. The application may expose some or all of its features and functionalities using a web service, which may utilize a number of known formats, techniques, and associated protocols for exposing the features and functionalities of the application in a discoverable manner. The web service may be exposed in a manner which provides for ease of interaction between the web service and other web services, or other application interfaces which are designed to be interoperable with the web service.

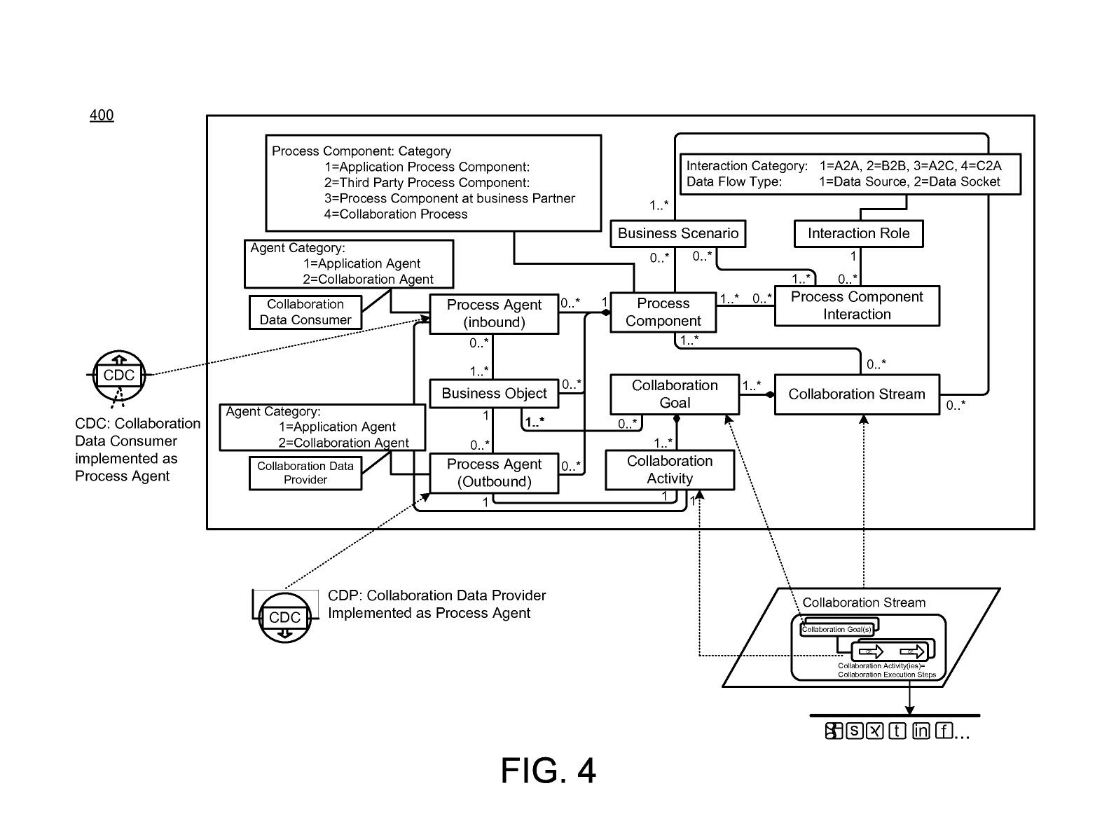

FIG. 4 shows an example metadata model integration 400 including a meta model of assigned collaboration enablement objects, in accordance with aspects of the disclosure. The example of FIG. 4 refers to relevant discussions of FIGS. 1-3.

In the example of FIG. 4, an entity to represent, implement, and associate collaboration execution in the collaboration stream that may be implemented as a new type of a process component. The collaboration stream may include the business object (BO) collaboration goals, wherein collaboration goals may be decomposed into different collaboration activities (e.g., implemented as nodes of the BO) that are as granular as necessary, such as, for example, meeting circles, specification work, prove of concept implementations, partner workshop that may be supported and/or represented by any means that makes sense in modern social and people centric application space.

In an example, a collaboration stream may include one or more business objects (BOs) for collaboration goals and/or collaboration activities. The collaboration goal(s) may include a sales quote for a particular customer (e.g., a service management contract). The collaboration activity(s) may provide for defining the contract, aligning with service contributors, setting up legal and regression terms (e.g., planning a workshop and alignment meeting with partners, writing a specification for the terms of usage and service level definition, meeting with customer and sign a contract, etc.). The example of FIG. 4 shows an outline of the modeling entities (CDC, CDP, CE, CPC) including their representation/implementation in the meta model.

While the structured business process models provide the master flow of consistent business data, all exceptional cases may need significant effort from business experts and may be error prone and inefficient as they delegate the responsibility for consistence out of the system into the collaboration business flow. The collaborative business flow may be based on people centric methods of mail threads, office documents, and individual tools that are known to need further explanation. Given an assumption that those proven artifacts may not be replaced by the system of record, they should be combined in a systematic way with the structured business process models. For instance a key question may be to find a right environment that allows combination with the system of record. At the same time, an objective may be to maintain the flexibility of people centric interaction patterns to share the same business context and jointly drive and finish particular business objectives.

The focus may be aimed at working in a ‘contextual manner’ meaning that the flow of business information, people interaction, and activities needs to be executable directly out of the context of the business process model. One challenge may be to find a right environment to allow people to define and execute their structure of work at run time. In some instances, collaborating experts may agree to contribute to an unstructured working model, and business experts may have an agreed execution strategy, but they struggle to find the right media to consistently expose and manage the business objectives. Accordingly, collaboration capabilities should allow people to communicate, stay informed, and take action on business process data without losing their business context, and collaborative ‘break-outs’ should be possible within every step of the end-to-end business processes. Thus, an objective of the disclosure is to introduce model centric collaboration where business process models include collaborative execution.

In accordance with aspects of the disclosure, while the structured business process models provide the master flow of consistent business data, all exceptional cases may require significant effort from business experts and may be considered error prone and inefficient as they delegate the responsibility for consistence out of the system into the collaboration business flow. The collaborative business flow may be based on people centric methods, such as, for example, mail threads, office documents, and/or individual tools. Given an assumption that the collaboration tools and methods may not be replaced by the system of record, there may be a solution to combine and link them in a systematic manner with the structured business process running in the system of record. In an implementation, the combination and linkage must be achieved without losing the flexibility and comfort of people centric interaction patterns and tools that are used to share the same business context and jointly drive and finish particular business objectives. This provided solution provided may enable a generic and model based integration of collaborative process steps, which are essential parts of the customer end-to-end business process, with the standard business process reflected in the system without limiting the flexibility and comfort of people centric interaction patterns.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, may be written in any form of programming language, including compiled or interpreted languages, and may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for user interaction, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other types of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of networks, such as communication networks, may include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system including instructions recorded on a non-transitory computer-readable medium and executable by at least one processor, the system comprising:
a collaboration manager configured to cause the at least one processor to manage a transactional business process flow based on business process constraints for structured business activities and collaborative process demands for unstructured business activities while maintaining a collaboration stream between the structured and unstructured business activities, wherein the collaboration manager includes:
a business process handler configured to derive a collaboration business process integration model for the structured business activities;
a collaboration handler configured to derive a collaboration metadata model for the unstructured business activities based on collaborative responses to each structured business activity;
an integration handler configured to integrate the collaboration business process integration model with the collaboration metadata model by aligning the business process constraints for the structured business activities with the collaborative process demands for the unstructured business activities; and
a transaction optimizer configured to schedule a sequence of structured business activities based on the business process constraints for the structured business activities and the collaborative process demands for the unstructured business activities while maintaining the collaboration stream between the structured and unstructured business activities.

2. The system of claim 1, wherein the structured business activities comprise application defined business activities.

3. The system of claim 2, wherein the application defined business activities comprise application-specific interaction business activities.

4. The system of claim 1, wherein the unstructured business activities comprise at least one of customer defined business activities, supplier defined business activities, and producer defined business activities.

5. The system of claim 4, wherein each of the customer defined business activities, supplier defined business activities, and producer defined business activities comprise personal interaction business activities of at least one of a customer, a supplier, and a producer.

6. The system of claim 1, wherein the integration handler is further configured to link each structured business activity with a corresponding collaborative response.

7. The system of claim 1, wherein the integration handler is further configured to link each collaborative response with a corresponding structured business activity.

8. The system of claim 1, wherein the integration handler is further configured to provide business constraint data for the collaboration business process integration model and customer demand data for the collaboration metadata model in an ordered sequence to maintain consistency between structured business activities and unstructured business activities.

9. The system of claim 1, wherein aligning the business process constraints for the structured business activities with the collaborative process demands for the unstructured business activities includes aligning available supplier and production capabilities with the collaborative process demands.

10. The system of claim 1, wherein the transaction optimizer is further configured to schedule the sequence of structured business activities in parallel.

11. The system of claim 1, further comprising a translation handler configured to provide one or more translations between a business process layer configured to provide the business process constraints for the structured business activities and a physical collaboration layer configured to provide the collaborative process demands for the unstructured business activities.

12. The system of claim 1, wherein data related to each customer demand is provided to each structured business activity, and wherein data related to each business constraint is provided to each unstructured business activity.

13. The system of claim 1, wherein the collaboration stream is defined as a set of objectives achieved by collaboration between the structured and unstructured business activities.

14. A computer-implemented method, comprising:
managing a transactional business process flow based on business process constraints for structured business activities and collaborative process demands for unstructured business activities while maintaining a collaboration stream between the structured and unstructured business activities by:
deriving a collaboration business process integration model for the structured business activities;
deriving a collaboration metadata model for the unstructured business activities based on collaborative responses to each structured business activity;
integrating the collaboration business process integration model with the collaboration metadata model by aligning the business process constraints for the structured business activities with the collaborative process demands for the unstructured business activities; and
scheduling a sequence of structured business activities based on the business process constraints for the structured business activities and the collaborative process demands for the unstructured business activities while maintaining the collaboration stream between the structured and unstructured business activities.

15. The method of claim 14, further comprising:
providing a link between each structured business activity and a corresponding collaborative response; and
providing another link between each collaborative response and a corresponding structured business activity.

16. The method of claim 14, further comprising providing business constraint data for the collaboration business process integration model and customer demand data for the collaboration metadata model in an ordered sequence to maintain consistency between structured business activities and unstructured business activities.

17. The method of claim 14, wherein aligning the business process constraints for the structured business activities with the collaborative process demands for the unstructured business activities includes aligning available supplier and production capabilities with the collaborative process demands.

18. A computer program product, the computer program product being tangibly embodied on a non-transitory computer-readable medium and comprising instructions that, when executed by at least one processor, are configured to:
manage a transactional business process flow based on business process constraints for structured business activities and collaborative process demands for unstructured business activities while maintaining a collaboration stream between the structured and unstructured business activities, wherein the instructions, when executed by the at least one processor, are further configured to:
derive a collaboration business process integration model for the structured business activities;
derive a collaboration metadata model for the unstructured business activities based on collaborative responses to each structured business activity;
integrate the collaboration business process integration model with the collaboration metadata model by aligning the business process constraints for the structured business activities with the collaborative process demands for the unstructured business activities; and
schedule a sequence of structured business activities based on the business process constraints for the structured business activities and the collaborative process demands for the unstructured business activities while maintaining the collaboration stream between the structured and unstructured business activities.

19. The computer program product of claim 18, wherein the instructions, when executed by the at least one processor, are further configured to:
provide a link between each structured business activity and a corresponding collaborative response;
provide another link between each collaborative response and a corresponding structured business activity; and
provide business constraint data for the collaboration business process integration model and customer demand data for the collaboration metadata model in an ordered sequence to maintain consistency between structured business activities and unstructured business activities.

20. The computer program product of claim 18, wherein aligning the business process constraints for the structured business activities with the collaborative process demands for the unstructured business activities includes aligning available supplier and production capabilities with the collaborative process demands.
